(19) United States
(12) Patent Application Publication
(10) Pub. No.: US 2025/0247360 A1
(43) Pub. Date: Jul. 31, 2025

(54) ENHANCED DEVICE ADDRESS ROTATION MANAGEMENT

(71) Applicant: Cisco Technology, Inc., San Jose, CA (US)

(72) Inventors: Domenico Ficara, Essertines-sur-Yverdon (CH); Stephen Rodriguez, Dallas, TX (US); Ugo Campiglio, Ecublens (CH); Stephen M. Orr, Syracuse, NY (US); Jerome Henry, Pittsboro, NC (US); Javier Contreras, Barcelona (ES); Amine Choukir, Ecublens (CH)

(21) Appl. No.: 19/043,388

(22) Filed: Jan. 31, 2025

Related U.S. Application Data
(63) Continuation of application No. 18/793,705, filed on Aug. 2, 2024.
(60) Provisional application No. 63/625,230, filed on Jan. 25, 2024.

(51) Int. Cl. H04L 61/5053; H04L 61/5038; H04L 101/622; H04W 12/02; H04W 84/12

(52) U.S. Cl. CPC H04L 61/5053; H04L 61/5038; H04W 12/02; H04L 2101/622; H04W 84/12

(57) ABSTRACT

Devices, systems, methods, and processes for managing device address rotation are described herein. Managing address rotation to ensure sufficient participation for effective obfuscation, while also offering it as an optional feature is challenging. An address rotation logic in a network device facilitates enhanced device address rotation by allowing mass address rotation at an epoch boundary, with an added property of being optional. The network device broadcasts a message indicating upcoming time intervals for address rotation and receives responses from user devices indicating their intent to participate in address rotation. The message further indicates a count of participating devices to encourage non-participating devices to reconsider their decision. This approach manages mass address rotations while allowing user devices to select their address rotation intervals. Additionally, the message provides an indication of how well a user device will hide in the crowd if they participate in address rotation at designated time intervals.

This application is a continuation of U.S. patent application Ser. No. 18/793,705, filed Aug. 2, 2024, which claims priority and the benefit of U.S. Provisional Patent Application No. 63/625,230, filed Jan. 25, 2024, which is incorporated by reference herein in its entirety.

The present disclosure relates to wireless communication. More particularly, the present disclosure relates to address rotation management in wireless devices.

### BACKGROUND

Wi-Fi provides seamless wireless connectivity for a multitude of devices in various environments such as homes, businesses, and public spaces. Certain advancements aim to enhance client privacy in wireless networks by enabling them to avoid tracking through rotation of media access control (MAC) addresses. It has been proposed that all stations (“STAs”) in a basic service set (BSS) simultaneously change their MAC addresses at predefined epoch boundaries. For example, at epoch boundaries, an Access Point (AP) may signal all connected STAs (e.g., user devices, client devices, endpoint devices, etc.) to rotate their MAC addresses. This coordinated MAC address rotation may make it difficult for an eavesdropper to track individual devices. In other words, the STAs change the MAC addresses collectively during each epoch boundary to obscure individual device identities.

However, eavesdroppers with surveillance equipment can monitor wireless local area network (WLAN) packets and track the activity of STAs associated with the WLAN. Thus, if an eavesdropper monitors a BSS over a time period, the eavesdropper can observe the sets of MAC addresses before and after the coordinated rotation. Although direct correlation to specific MAC addresses from one epoch to the next may not be possible, statistical methods can be utilized to identify STAs based on consistent traffic patterns.

Further, it may be difficult to force an STA to rotate its MAC address. For example, the STA may have a privacy algorithm that requires slower address rotation, or the STA may be inactive at the end of the epoch, or the like. Such STAs may independently choose their epoch boundaries for MAC address rotation. While this avoids the challenges of forced synchronization, it can introduce a “confusion issue” where a limited change in MAC addresses during a small time interval can make it easier for an eavesdropper to track a specific device.

SUMMARY OF THE DISCLOSURE

Systems and methods for facilitating enhanced device address rotation management in accordance with embodiments of the disclosure are described herein. In some embodiments, a device includes a processor, a network interface controller configured to provide access to a network, and a memory communicatively coupled to the processor, wherein the memory includes an address rotation logic that is configured to identify one or more upcoming time intervals for address rotation, broadcast a message indicating the one or more upcoming time intervals, and receive, from at least one network device, a response for the broadcasted message, wherein the response is configured to indicate whether the at least one network device intends to participate in the address rotation within at least one of the one or more upcoming time intervals.

In some embodiments, the address rotation logic is further configured to broadcast the message at specific time periods.

In some embodiments, the response is configured to indicate that the at least one network device intends to opt out from participating in the address rotation within the at least one of the one or more upcoming time intervals.

In some embodiments, the response is configured to indicate that the at least one network device intends to participate in the address rotation within the at least one of the one or more upcoming time intervals.

In some embodiments, the address rotation logic is further configured to determine a count of network devices that have opted to participate in the address rotation within an upcoming time interval of the one or more upcoming time intervals.

In some embodiments, the broadcasted message is further configured to indicate the determined count of network devices for the upcoming time interval.

In some embodiments, the address rotation logic is further configured to update the count of network devices that have opted to participate in the address rotation within the upcoming time interval based on the response indicating that the at least one network device intends to participate in the address rotation within the upcoming time interval.

In some embodiments, the address rotation logic is further configured to re-broadcast the message prior to the upcoming time interval, wherein the re-broadcasted message is configured to indicate the updated count of network devices that have opted to participate in the address rotation within the upcoming time interval.

In some embodiments, prior to broadcasting the message, the address rotation logic is further configured to set a threshold count on a minimum number of network devices that have to participate in the address rotation at an upcoming time interval of the one or more upcoming time intervals.

In some embodiments, the broadcasted message is further configured to indicate the threshold count for the upcoming time interval.

In some embodiments, the broadcasted message is further configured to indicate whether the threshold count is reached within a historical time interval prior to the upcoming time interval.

In some embodiments, the broadcasted message includes a flag that indicates whether the threshold count is reached within the historical time interval.

In some embodiments, the broadcasted message is further configured to indicate a count of network devices that participated in the address rotation within the historical time interval.

In some embodiments, the address rotation logic is further configured to transmit a notification prior to an upcoming time interval of the one or more upcoming time intervals.

In some embodiments, the notification is configured to alert the at least one network device regarding the upcoming time interval for the address rotation.

In some embodiments, the broadcasted message is further configured to indicate a start time of an upcoming time interval of the one or more upcoming time intervals.

In some embodiments, the address rotation logic is further configured to encrypt the message prior to broadcasting the message.

In some embodiments, the address rotation corresponds to Media Access Control (MAC) address rotation.

In some embodiments, an address rotation logic is configured to receive a message indicating one or more upcoming time intervals for address rotation, wherein the device is associated with an address, determine, in response to receiving the message, whether to participate in the address rotation within any of the one or more upcoming time intervals, and transmit a response based on the determination, wherein the response is configured to indicate whether the device intends to participate in the address rotation within at least one of the one or more upcoming time intervals.

In some embodiments, a method includes identifying one or more upcoming time intervals for Media Access Control (MAC) address rotation, broadcasting a message indicating the one or more upcoming time intervals, and receiving, from at least one network device, a response for the broadcasted message, wherein the response is configured to indicate whether the at least one network device intends to participate in the MAC address rotation within at least one of the one or more upcoming time intervals.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system in accordance with various embodiments of the disclosure;

FIG. 2 is a conceptual depiction of a communication layer architecture in accordance with various embodiments of the disclosure;

FIG. 3 is a conceptual network diagram of various environments in which an address rotation logic may operate in accordance with various embodiments of the disclosure;

FIG. 4 is a conceptual block diagram of a network architecture implementing enhanced address rotation in accordance with various embodiments of the disclosure;

FIG. 5 is a flowchart showing a process for broadcasting a message for coordinating device address rotation in accordance with various embodiments of the disclosure;

FIG. 6 is a flowchart showing a process for facilitating device address rotation in accordance with various embodiments of the disclosure;

FIG. 7 is a flowchart showing a process for facilitating device address rotation in accordance with various embodiments of the disclosure;

FIG. 8 is a flowchart showing a process for device address rotation in accordance with various embodiments of the disclosure;

FIG. 9 is a flowchart showing a process for trust-based address rotation in a wireless device in accordance with various embodiments of the disclosure;

FIG. 10 is a flowchart showing a process for coordinating device address rotation in accordance with various embodiments of the disclosure; and

FIG. 11 is a conceptual block diagram of a device suitable for configuration with an address rotation logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that can facilitate enhanced device address rotation in wireless networks. IEEE standard 802.11bi aims to enhance privacy in wireless networks by enabling stations “STAs” (e.g., user devices, network devices, endpoint devices, etc.) to avoid tracking through rotation of media access control (MAC) addresses. In a known implementation, an Access Point (AP) may signal all STAs in a base service set (BSS) to simultaneously change their MAC addresses at predefined epoch boundaries. This coordinated MAC address rotation may make it difficult for an eavesdropper to track individual devices. In other words, the STAs change their identifiers collectively at specific time intervals, making it difficult for eavesdroppers to track. However, if an eavesdropper is monitoring the BSS, the eavesdropper can detect the MAC addresses before and after the synchronized rotation. For example, an eavesdropper can understand that a sudden change in multiple MAC addresses at a particular time instance in a network is due to MAC address rotation, and not due to the arrival of new STAs or the departure of old STAs from the network. Though direct correlation of specific MAC addresses from one epoch to the next might be challenging, statistical analysis can reveal an STA based on consistent traffic patterns. For example, there can be two sets of ‘N’ MAC addresses, one during a first epoch duration and one during a second epoch duration. An eavesdropper, in theory, may be unable to determine which MAC address in the first epoch duration is translated to which MAC address in the second epoch duration. However, if they know that the event was MAC address rotation, they can statistically identify STAs based on their traffic pattern. In another implementation, STAs may be allowed to independently choose their epoch boundaries for MAC address rotation. However, such an approach may lead to overheads and increase processing complexity. In other words, group address rotation may be useful for obfuscation, but it may be difficult to force every STA to rotate its address.

Therefore, in order to enhance privacy in networks, the present disclosure provides a solution that overcomes the abovementioned problems by supporting both group address rotation and individual rotation simultaneously. The present disclosure may ensure sufficient participation in group address rotation to achieve effective obfuscation while allowing STAs to select their address rotation preferences. Consequently, potential eavesdroppers may be confused by such a hybrid address rotation approach, making it difficult to track STAs based on traffic patterns. In other words, the present disclosure balances enhanced privacy with practical considerations, such as varied STA behaviors and privacy algorithms, and offers a flexible, adaptable address rotation solution without imposing significant overhead or complexity.

“STAs” (for example, smartphones, laptops, tablets, smartwatches, smart appliances, wearable devices, Internet of Things “IoT” devices, or the like) in a wireless network may be required to rotate their addresses (e.g., MAC addresses) for enhancing privacy. In other words, an STA may change its MAC address at certain time intervals to prevent tracking and profiling based on a static MAC address. The present disclosure provides an AP that coordinates address rotation of a plurality of STAs in a network while allowing the plurality of STAs to select their address rotation preferences.

In a variety of embodiments, the AP may include an address rotation logic that facilitates and manages address rotation of the plurality of STAs. In more embodiments, the AP may identify one or more upcoming time intervals for the address rotation. The AP may be configured to plan and identify the one or more upcoming time intervals to ensure coordinated address rotation among a sufficient number of STAs. The one or more upcoming time intervals may include, for example, planned upcoming epoch boundaries, next bus indices, or next bus announcements for performing address rotation. In other words, the one or more upcoming time intervals may refer to epoch boundaries at which the STAs can change their addresses to enhance privacy and prevent tracking.

In additional embodiments, the AP may broadcast a message indicating the one or more upcoming time intervals. By broadcasting the message, the AP may ensure that the connected STAs are informed and prepared for an upcoming address rotation event in an upcoming time interval of the one or more upcoming time intervals. The message can be broadcasted as a management frame, an announcement frame, a beacon, or the like. In various embodiments, the message may also include expected start timestamps of the one or more upcoming time intervals. In numerous embodiments, the AP may encrypt the message before broadcasting the message.

In further embodiments, the AP may receive, from at least one STA, a response to the broadcasted message. The response may be configured to indicate whether the STA intends to participate in the address rotation within at least one of the one or more upcoming time intervals. The response may include any one of a confirmation of participation in address rotation within any of the one or more upcoming time intervals or a denial of participation in address rotation. In other words, multiple STAs may opt to participate in the address rotation while some other STAs may opt out of participating in the address rotation, and accordingly convey their responses to the AP.

In still more embodiments, prior to broadcasting the message, the AP may be configured to set a threshold count on a minimum number of network devices (e.g., STAs) that have to participate in the address rotation in any of the one or more upcoming time intervals. Setting the threshold count may provide a crowd obfuscation parameter by ensuring that a sufficient number of STAs change their MAC addresses at the same time. Thus, enhancing the effectiveness of “hiding in the crowd.” In other words, the threshold count may ensure that the STAs are secured and eavesdroppers monitoring the network are unable to track the STAs due to increased entropy of the STAs changing their MAC addresses at the same time. In such embodiments, the broadcasted message may be further configured to indicate the threshold counts set for the one or more upcoming time intervals.

In yet various embodiments, the AP may be further configured to collect and aggregate the responses from the STAs. Based on the responses that confirm participation in the address rotation in an upcoming time interval indicated by the broadcasted message, the AP may check whether the threshold count is satisfied. For example, the AP may have set a threshold count of ‘10’. If ‘12’ STAs have responded to participate in the address rotation, the address rotation may proceed at the upcoming time interval, ensuring there is a significant number of STAs changing their addresses simultaneously. However, if only ‘8’ STAs have opted to participate in the address rotation, the AP may delay the address rotation until more STAs join in, ensuring the threshold count is satisfied.

In yet more embodiments, prior to broadcasting the message, the AP may be further configured to determine a historical count of network devices (e.g., STAs) that had participated in the address rotation in a historical time interval, for example, prior to the one or more upcoming time intervals. In such embodiments, the broadcasted message may be further configured to indicate the historical count. For example, some STAs may have opted in but failed to change their addresses at the historical time interval, while other STAs may have opted out but still changed their address at the historical time interval. Thus, the broadcasted message may provide an estimate of the actual number of STAs that had participated in the address rotation in the historical time interval. In many embodiments, the broadcasted message may be further configured to indicate whether the threshold count was reached in the historical time interval. For example, by indicating, in the broadcasted message, whether the threshold count was reached in the historical time interval, the AP may indirectly indicate a likelihood of the threshold count being satisfied within an upcoming time interval as well. In still yet more embodiments, whether the threshold count was reached in the historical time interval can be indicated by a flag (e.g., a Boolean flag) in the broadcasted message. For example, if the threshold count was satisfied in the historical time interval, the flag can be set to “1”; however, if the threshold count was not satisfied in the historical time interval, the flag can be set to “0”.

In still further embodiments, the AP may be further configured to re-broadcast the message at specific time periods, for example, prior to the one or more upcoming time intervals. Prior to re-broadcasting the message, the AP may be configured to determine a count of network devices (e.g., STAs) that have opted to participate in the address rotation within an upcoming time interval of the one or more upcoming time intervals. Determining the count of STAs that have opted to participate in the address rotation before broadcasting the message may ensure that there is sufficient participation to proceed with the address rotation. This helps maintain the effectiveness of the address rotation by avoiding unnecessary broadcasts if the threshold count is already met. In still additional embodiments, in the re-broadcasted message, the AP may further include, at least for the earliest upcoming time interval, the count of STAs that have opted to participate in the address rotation within the earliest upcoming time interval. Thus, in every re-broadcast, the AP may update the count of STAs that have opted to participate in the address rotation for any of the one or more upcoming time intervals.

In still yet further embodiments, the AP may be configured to transmit a notification prior to an upcoming time interval of the one or more upcoming time intervals. This notification may be configured to alert the STAs about the upcoming time interval for address rotation. By providing an advance alert notification, the AP may ensure that STAs are prepared and aware of the scheduled address rotation, thus facilitating smoother coordination and maximum participation.

In many further embodiments, an STA may receive the broadcasted message indicating the one or more upcoming time intervals for address rotation. The STA may determine whether to participate in the address rotation within any of the one or more upcoming time intervals. The STA may further transmit a response indicating whether the STA intends to participate in the address rotation within at least one of the one or more upcoming time intervals. In other words, multiple STAs may opt to participate for address rotation and accordingly transmit corresponding opt in responses to the AP, indicating an intention to participate in the address rotation. Some other STAs may opt out of participating in the address rotation and accordingly transmit opt out responses to the AP. In many additional embodiments, the STAs may unicast or broadcast the responses to the AP.

In several embodiments, the STA may be configured to select an upcoming time interval among the one or more upcoming time intervals based on the count of the network devices that have opted for address rotation within the upcoming time interval. In other words, each STA may set its criteria for how many other STAs need to be involved in the address rotation for the STA to participate. The upcoming time interval that has the maximum count of STAs participating in the address rotation may be selected as the upcoming time interval for address rotation by the STA.

In further additional embodiments, the STA may perform address rotation earlier than the prescribed or selected upcoming time interval. In such a scenario, the STA may transmit a response frame to the AP that had broadcasted the message for address rotation. The response frame may include an announce bit configured to indicate that the STA is changing the address prior to the prescribed upcoming time interval by a predefined time.

In numerous additional embodiments, the STA may be configured to identify a trust level of the network. Based on the identified trust level, the STA may be configured to determine a periodicity of address rotation. For example, in one scenario, if the trust level is identified to be fully untrusted, the STA may set a first periodicity value and select those upcoming time intervals from the one or more upcoming time intervals that satisfy the first periodicity value for address rotation. In another scenario, if the trust level is identified to be semi untrusted, the STA may be configured to set a second periodicity value and select those upcoming time intervals from the one or more upcoming time intervals that satisfy the second periodicity value for address rotation. In yet another scenario, if the trust level is identified to be fully trusted, the STA may determine that address rotation is not required.

Although it is described that the address rotation may be facilitated by an AP, the scope of the present disclosure is not limited to it. In still yet additional embodiments, instead of the AP coordinating the address rotation, other wireless devices such as a wireless network controller, an STA, or the like can coordinate the address rotation. For example, among the plurality of STAs, one STA can assume the role of a “leader” STA. The leader STA can identify an upcoming time interval for address rotation and broadcast a message to announce its address rotation within the upcoming time interval to other STAs within the network. In response to the broadcasted message, the leader STA may receive a response from at least one other STA, indicating an intent of the other STA to change its address within the upcoming time interval. In other words, multiple other STAs may opt to change their address (e.g., MAC address) along with the leader STA and accordingly transmit corresponding responses to the leader STA.

Thus, the enhanced group address rotation at the epoch boundaries without mandating the STAs to change their MAC addresses offers significant advantages, including enhanced privacy through mass rotation, user autonomy by allowing devices to choose whether to participate in address rotation, and informed decision-making through feedback on the “crowd obfuscation parameter”. The mass address rotation of the devices makes a large anonymity set, increasing entropy that enables the devices to hide in the crowd. The participating devices can also opt to change their addresses (e.g., MAC addresses or other identifiers) based on an indication of how well the devices would hide in the crowd if they were to change their addresses. This approach can improve network performance by optimizing management during coordinated address rotations, can reduce overhead by not mandating participation, and can adapt to varying levels of device involvement. Additionally, it encourages best practices for privacy and security, supports diverse environments, and remains scalable and efficient as the number of devices grows, thereby ensuring robust and secure network operations.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in still yet more embodiments, may alternatively be embodied by or implemented as a component.

A circuit, as used herein, comprises a set of one or more electrical and/or electronic components providing one or more pathways for electrical current. In many additional embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

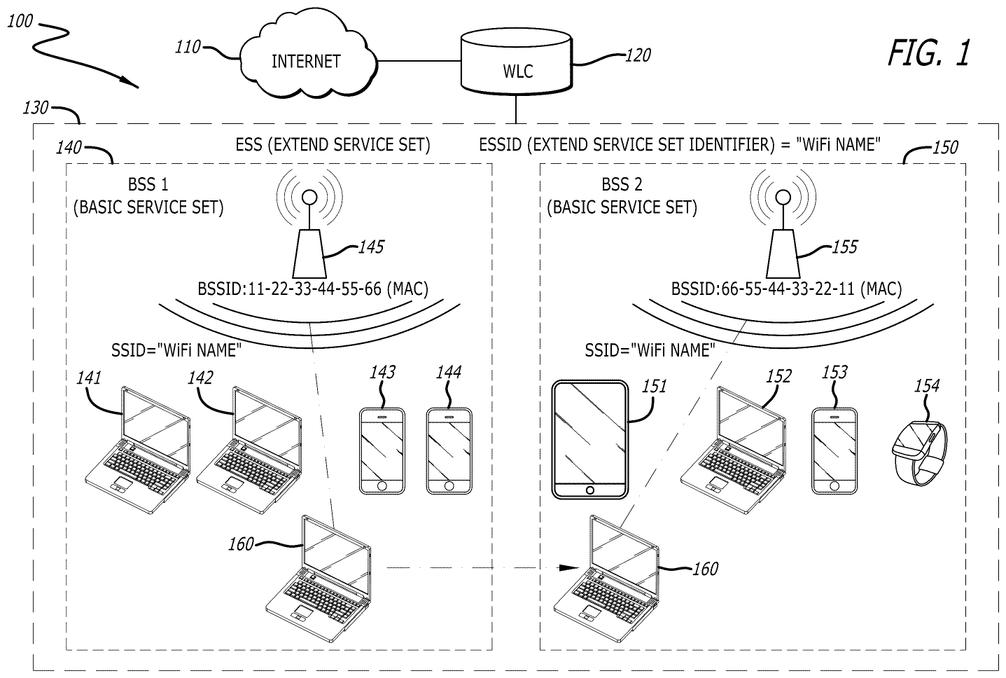

Referring to FIG. 1, a schematic block diagram of a wireless local networking system 100 in accordance with various embodiments of the disclosure is shown. Wireless local networking standards play a crucial role in enabling seamless communication and connectivity between various devices within localized areas. One of the most prevalent standards is Wi-Fi, which is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. The 802.11b (also referred to as 802.11 High Rate or Wi-Fi) provides 11 Mbps transmission (with a fallback to 5.5, 2, and 1 Mbps) in the 2.4 GHz band. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes comprising devices like laptops, smartphones, or other Wi-Fi-enabled devices operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's important to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends a service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has been associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

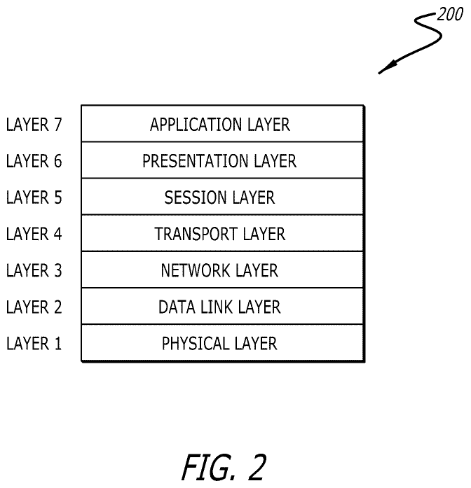

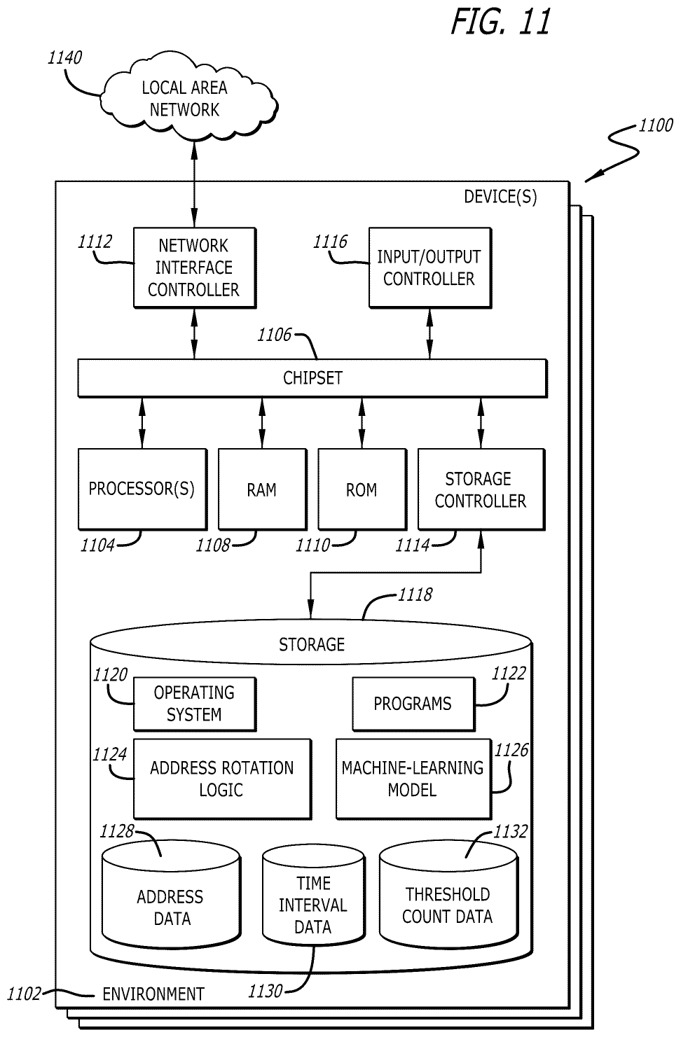

The network can include a variety of user end devices that connect to the network. These devices can sometimes be referred to as stations (i.e., “STAs”). Each device is typically configured with a medium access control (“MAC”) address in accordance with the IEEE 802.11 standard. As described in more detail in FIG. 2, a physical layer can also be configured to communicate over the wireless medium as described in more detail of FIG. 11, various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140, and BSS 2 150 all broadcast and are configured with the same SSID “Wi-Fi Name”, which can be a BSSID for each of the BSS 1 140 and BSS 2 150 as well as an ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). The third notebook 160 is communicatively collected to both the first BSS 1 140 and the second BSS 2 150. In this setup, third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-11 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance with the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the fourth transport layer can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with the embodiments of the disclosure. For example, various aspects described herein may reside or be carried out on one layer, or a plurality of layers. The elements depicted in FIG. 2 may also be interchangeable with other elements of FIG. 1 and FIGS. 3-11 as required to realize a particularly desired embodiment.

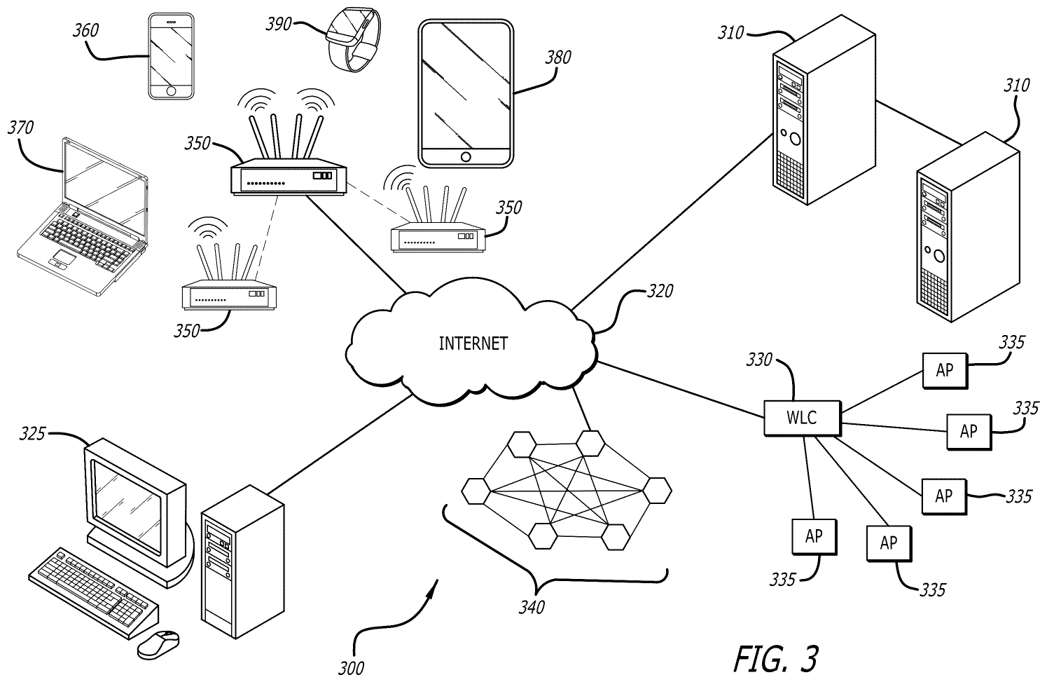

Referring to FIG. 3, a conceptual network diagram 300 of various environments in which an address rotation logic may operate in accordance with various embodiments of the disclosure is shown. Those skilled in the art will recognize that the address rotation logic can include various hardware and/or software deployments and can be configured in a variety of ways. In many embodiments, the address rotation logic can be configured as a standalone device, exist as a logic in another network device, be distributed among various network devices operating in tandem, or be remotely operated as part of a cloud-based network management tool. In further embodiments, one or more servers 310 can be configured with the address rotation logic or can otherwise operate as the address rotation logic. In many embodiments, the address rotation logic may operate on one or more servers 310 connected to a communication network 320 (shown as the “Internet”). The communication network 320 can include wired networks or wireless networks. The address rotation logic can be provided as a cloud-based service that can service remote networks, such as, but not limited to a deployed network 340.

However, in additional embodiments, the address rotation logic may be operated as a distributed logic across multiple network devices. In the embodiment depicted in FIG. 3, a plurality of network access points (APs) 350 can operate as the address rotation logic in a distributed manner or may have one specific device operate as the networking logic for all of the neighboring or sibling APs 350. The APs 350 may facilitate Wi-Fi connections for various electronic devices, such as but not limited to, mobile computing devices including laptop computers 370, cellular phones 360, portable tablet computers 380, and wearable computing devices 390.

In further embodiments, the address rotation logic may be integrated within another network device. In the embodiment depicted in FIG. 3, a wireless LAN controller (WLC) 330 may have an integrated address rotation logic that the WLC 330 can use to monitor or control power consumption of the APs 335 that the WLC 330 is connected to, either wired or wirelessly. In still more embodiments, a personal computer 325 may be utilized to access and/or manage various aspects of the address rotation logic, either remotely or within the network itself. In the embodiment depicted in FIG. 3, the personal computer 325 communicates over the communication network 320 and can access the address rotation logic of the servers 310, the network APs 350, or the WLC 330. In still more embodiments, the address rotation logic may be integrated into laptop computers 370, cellular phones 360, portable tablet computers 380, and wearable computing devices 390.

Although a specific embodiment for various environments that the address rotation logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the address rotation logic may be provided as a device or software separate from the WLC 330, or the address rotation logic may be integrated into the WLC 330. The elements depicted in FIG. 3 may also be interchangeable with other elements of FIGS. 1-2 and FIGS. 4-10 as required to realize a particularly desired embodiment.

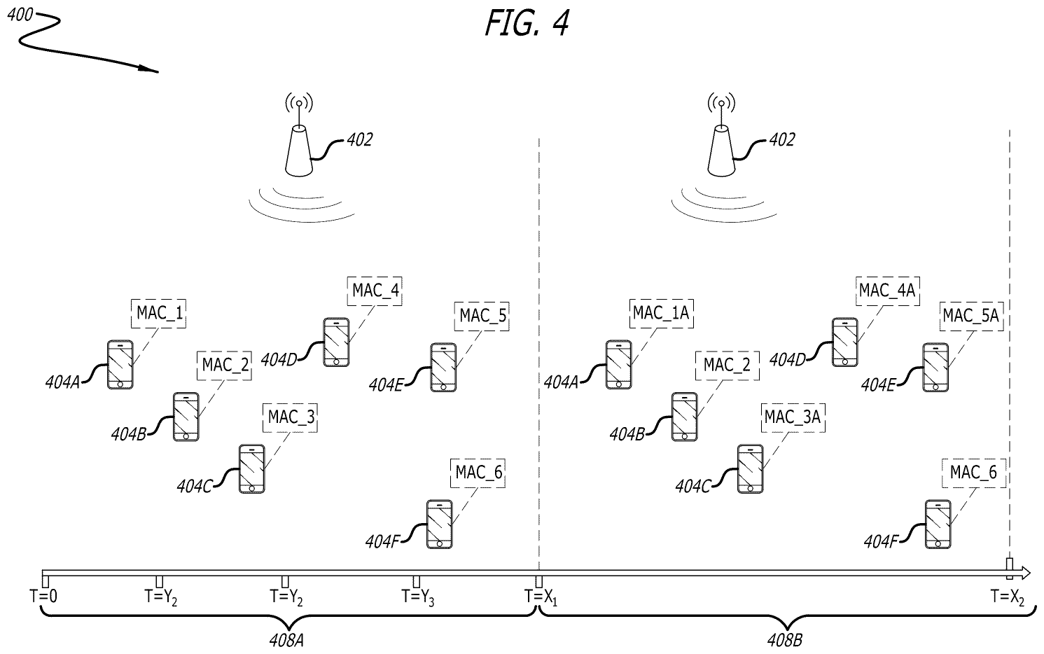

Referring to FIG. 4, a conceptual block diagram of a network architecture 400 implementing enhanced address rotation in accordance with various embodiments of the disclosure is shown. The embodiments shown in FIG. 4 may illustrate a scenario where an AP 402 may be deployed to provide network access to a plurality of network devices (for example, STAs 404A-F). In the embodiment depicted in FIG. 4, the AP 402 may include an address rotation logic configured to coordinate MAC address rotation. The address rotation logic can include various hardware and/or software deployments and can be configured in a variety of ways. For example, the address rotation logic can be a set of instructions stored within a non-volatile memory that, when executed by a processor(s) can carry out the steps to coordinate address rotation by the STAs 404A-F. For the sake of ongoing description, operations performed by the address rotation logic are considered as performed by the AP 402 as the address rotation logic is included in the AP 402.

In FIG. 4, various scenarios are depicted with respect to a time axis 406. The STAs 404A-F may be associated with their respective addresses, for example, MAC addresses. For example, during an epoch duration 408A between T=0 to T=X₁, the STA 404A has ‘MAC_1’ as the MAC address, the STA 404B has ‘MAC_2’ as the MAC address, the STA 404C has ‘MAC_3’ as the MAC address, the STA 404D has ‘MAC_4’ as the MAC address, the STA 404E has ‘MAC_5’ as the MAC address, and the STA 404F has ‘MAC_6’ as the MAC address. Examples of the STAs 404A-F may include, but are not limited to, smartphones, laptops, tablets, smartwatches, smart appliances, wearable devices, Internet of Things “IoT” devices, or the like. In other words, the STAs 404A-F can be user devices, network devices, endpoint devices, client devices, or the like.

In order to provide privacy and prevent tracking of the STAs 404A-F, in many embodiments, the AP 402 may be configured to announce time schedules for performing coordinated address rotations. In a number of embodiments, the AP 402 may be configured to identify one or more upcoming time intervals (for example, T=X₁ and T=X₂) for scheduling the address rotations. The AP 402 may plan and identify the upcoming time intervals to ensure coordinated address rotation among a sufficient number of STAs. The upcoming time intervals may include, for example, planned epoch boundaries, next bus indices, or next bus announcements for performing address rotation. In other words, the upcoming time intervals (for example, T=X₁ and T=X₂) may refer to epoch boundaries of epoch durations 408A and 408B at which one or more of the STAs 404A-F may change their MAC addresses to enhance privacy and prevent tracking.

In additional embodiments, the AP 402 may be further configured to set a threshold count on a minimum number of network devices that have to participate in address rotation within a given time interval. Setting the threshold count may provide a crowd obfuscation parameter by ensuring that a sufficient number of STAs change their MAC addresses at the same time. Thus, enhancing the effectiveness of “hiding in the crowd.” In other words, the threshold count may ensure that the STAs 404A-F are secured from eavesdroppers monitoring the network due to the minimum number of STAs changing their MAC addresses at the same time.

In a variety of embodiments, the AP 402 may broadcast a message indicating the upcoming time intervals X₁ and X₂ for address rotation and threshold counts set for the respective upcoming time intervals X₁ and X₂. The message can be broadcasted in a management frame, an announcement frame, a beacon, or the like. In an example, the AP 402 may broadcast the message at time instance T=0. The message may further indicate an expected start time (also referred to as “timestamp”) of each of the upcoming time intervals X₁ and X₂. In numerous embodiments, the AP 402 may be configured to encrypt the message before broadcasting the message. Encrypting the message prior to broadcast may ensure that only authorized devices are able to access the message. The AP 402 may utilize one or more known encryption technologies, for example, symmetric key encryption, asymmetric key encryption, HASH-based encryption, or the like. Further, the AP 402 may ensure that the broadcasted message is decryptable by the STAs 404A-F.

In more embodiments, prior to broadcasting the message, the AP 402 may be further configured to determine a historical count of network devices that had participated in address rotation in a historical time interval, for example, prior to the upcoming time intervals X₁ and X₂. In such embodiments, the broadcasted message may be further configured to indicate the historical count of network devices. For example, some network devices may have opted to participate in address rotation at the historical time interval but failed to change their MAC addresses at the historical time interval, while other network devices may not have opted but still changed their MAC addresses at the historical time interval. Thus, the broadcasted message may provide an estimate of an actual number of network devices that changed their MAC addresses within the historical time interval. In numerous additional embodiments, the broadcasted message may be further configured to indicate whether the threshold count was reached within the historical time interval. For example, by indicating, in the broadcasted message, whether the threshold count was reached within the historical time interval, the AP 402 may indirectly indicate a likelihood of the threshold count being satisfied within the upcoming time intervals X₁ and X₂ as well. In several embodiments, whether the threshold count was reached within the historical time interval can be indicated by a flag (e.g., a Boolean flag) in the broadcasted message. For example, if the threshold count was satisfied within the historical time interval, the flag can be set to “1”; however, if the threshold count was not satisfied within the historical time interval, the flag can be set to “0”.

In further embodiments, the STAs 404A-F may receive the broadcasted message and determine whether to participate in address rotation in any of the upcoming time intervals X₁ and X₂. In an example scenario, the STAs 404A, 404B, 404C, and 404D may determine to participate in address rotation within the upcoming time interval X₁. While the STAs 404E and 404F may determine to opt out of participating in the address rotation within the upcoming time interval X₁. Accordingly, the STAs 404A, 404B, 404C and 404D may transmit responses to the AP 402 indicating their intention to participate in the address rotation within the upcoming time interval X₁, while the STAs 404E and 404F may transmit responses to the AP 402 indicating their intention to opt out of the address rotation. In an example, the responses can be transmitted via action frames. In several additional embodiments, some STAs may not provide any response to the broadcasted message. For example, such STAs may have already transmitted responses or may choose to ignore the broadcasted message.

In several more embodiments, the AP 402 may receive the responses from the STAs 404A-F. In still more embodiments, the AP 402 may further collect and aggregate the responses from the STAs 404A-F. Based on the responses that confirm participation in the address rotation, for example, within the upcoming time interval X₁, the AP 402 may determine whether the minimum threshold count set for the upcoming time interval X₁ is satisfied or not. For example, the AP 402 may have set a threshold count of ‘3’ for the upcoming time interval X₁. In such a scenario, if ‘4’ STAs have responded to participate in the address rotation within the upcoming time interval X₁, the AP 402 may establish that the threshold count is satisfied for the upcoming time interval X₁. and the address rotation proceeds. Thus, ensuring there is a significant number of STAs changing their MAC addresses simultaneously to maintain the crowd obfuscation parameter. If, however, only ‘3’ STAs have opted to change their MAC addresses, the AP 402 may delay the address rotation within the upcoming time interval X₁ until more STAs join, ensuring the threshold count is satisfied.

In the current example, the AP 402 may determine that ‘4’ STAs (e.g., the STAs 404A, 404B, 404C and 404D) have opted to participate in the address rotation within the upcoming time interval X₁. In still additional embodiments, the AP 402 may be further configured to re-broadcast the message by including the determined count of network devices that have opted to participate in the address rotation within the upcoming time intervals X₁ and X₂. Such inclusion of the count of the network devices in the broadcasted message may prompt (e.g., encourage) more STAs to participate in the address rotation within the upcoming time intervals X₁ and X₂. In still further embodiments, the AP 402 may re-broadcast the updated message with the count of network devices at a time interval T=Y₁. Based on the responses received to the re-broadcasted message, the AP 402 may determine a new count of network devices that have opted to participate in the address rotation within the upcoming time intervals X₁ and X₂, and update the message for subsequent re-broadcast. For example, the AP 402 may re-broadcast the message with the updated count of network devices at time intervals T=Y₂ and Y₃.

In many further embodiments, the AP 402 may re-broadcast the message based on whether the minimum threshold counts set for the upcoming time intervals X₁ and X₂ are satisfied or not. For example, if the minimum threshold count set for the upcoming time interval X₁ is satisfied after the re-broadcast time interval T=Y₁, the AP 402 may not re-broadcast the message at subsequent time intervals T=Y₂, Y₃. In many additional embodiments, the AP 402 may set the frequency of re-broadcast based on a difference between the minimum threshold count set for an upcoming time interval and corresponding count of network devices that have opted to participate in the address rotation. For example, if the count of network devices that have opted to participate in the address rotation within the upcoming time interval X₁ is significantly lower than the minimum threshold count set for the upcoming time interval X₁, the AP 402 may increase the frequency of re-broadcast. However, if the count of network devices that have opted to participate in the address rotation within the upcoming time interval X₁ is equal to or greater than the minimum threshold count set for the upcoming time interval X₁, the AP 402 may maintain default frequency or reduce the frequency of re-broadcast.

In yet more embodiments, the AP 402 may be further configured to transmit a notification prior to the upcoming time interval X₁. This notification may be configured to alert the STAs 404A-F about the upcoming time interval X₁ for the address rotation. By providing an advance alert notification, the AP 402 may ensure that STAs 404A-F are prepared and aware of the scheduled address rotation, thus facilitating smoother coordination and maximum participation. In an example, the AP 402 transmits the notification a predetermined duration (for example, 1 minute, 10 seconds, or the like) before the upcoming time interval X₁.

In a non-limiting example shown in FIG. 4, at epoch boundary T=X₁, the STA 404B may be sleeping and fail to change its MAC address as communicated to the AP 402. Further, the STA 404E that had not opted to participate in the address rotation at T=X₁ may change its MAC address from ‘MAC_5’ to ‘MAC_5A’. As shown in FIG. 4, at T=X₁, the end STAs 404A, 404C, 404D, and 404E have changed their MAC addresses, while the STAs 404B and 404F did not change their MAC addresses. Thus, during the epoch duration 408B between T=X₁ to T=X₂, the STA 404A has ‘MAC_1A’ as the new MAC address, the STA 404B has ‘MAC_2’ as the MAC address, the STA 404C has ‘MAC_3A’ as the new MAC address, the STA 404D has ‘MAC_4A’ as the new MAC address, the STA 404E has ‘MAC_5A’ as the new MAC address, and the STA 404F has ‘MAC_6’ as the MAC address.

In still yet more embodiments, the AP 402 may consider T=X₁ as the historical time interval for the upcoming time interval X₂. In still yet further embodiments, the AP 402 may determine a historical count of network devices that had participated in the address rotation within the historical time interval X₁. In the current example, the historical count of network devices that had participated in the address rotation within the historical time interval X₁ is determined as ‘4’. Further, since the historical count of network devices that participated in the address rotation at the historical time interval X₁ exceeded the threshold count ‘₃’, the AP 402 may set the flag to ‘₁’ when broadcasting a new message for the upcoming time interval X₂ and so on.

Although a specific embodiment for a block diagram of a network architecture for carrying out the various steps, processes, methods, and operations described herein is discussed with respect to FIG. 4, any of a variety of systems and/or processes may be utilized in accordance with embodiments of the disclosure. For example, the above-described operations performed by the AP 402 can also be performed by another network device, an STA, a WLC, or the like. In such a scenario, the STA may assume the role of a ‘leader’ STA and broadcast a message announcing the intent of the leader STA to rotate its MAC address at an upcoming time interval. The leader STA may receive one or more responses from one or more other STAs regarding their intent to join the leader STA for address rotation. The elements depicted in FIG. 4 may also be interchangeable with other elements of FIGS. 1-3 and 4-11 as required to realize a particularly desired embodiment.

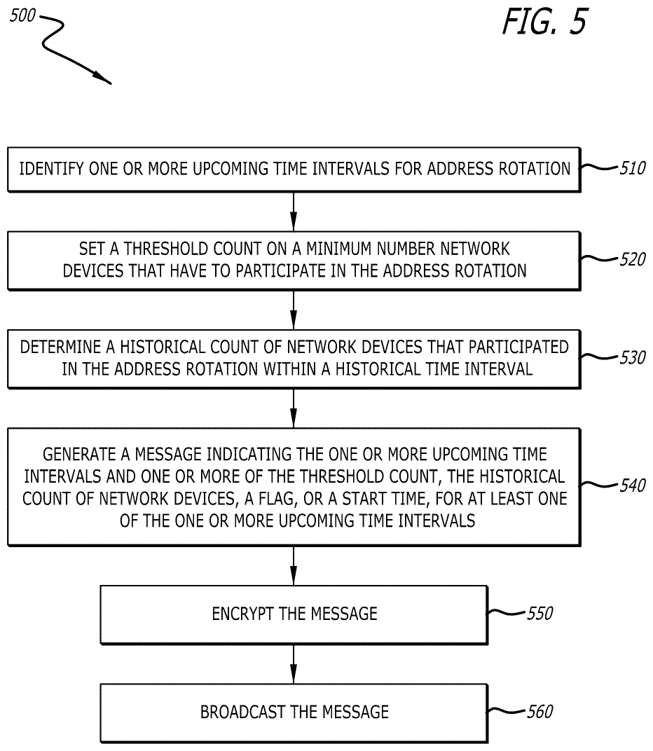

Referring to FIG. 5, a flowchart depicting a process 500 for broadcasting a message for coordinating device address rotation in accordance with various embodiments of the disclosure is shown. In many embodiments, the process 500 may identify one or more upcoming time intervals for address rotation (block 510). The one or more upcoming time intervals may include time schedules at which a plurality of network devices (interchangeably referred to as “STAs”) connected to a network can select to undergo a coordinated address rotation. In an example, the process 500 can be performed by an AP communicatively coupled to the plurality of STAs. The one or more upcoming time intervals may include, for example, epoch boundaries at which address rotation can happen. The plurality of STAs may select any of the one or more upcoming time intervals for performing address rotation, for example, MAC address rotation, Internet Protocol (IP) address rotation, or any other suitable identifier rotation. Examples of the plurality of STAs may include, but are not limited to, smartphones, laptops, tablets, smartwatches, smart appliances, wearable devices, IoT devices, or the like.

In a number of embodiments, the process 500 may set a threshold count on a minimum number of network devices that have to participate in the address rotation (block 520). In various embodiments, the threshold count may refer to a crowd obfuscation parameter that is required to provide increased entropy during address rotation to enhance privacy and security. Such a crowd obfuscation parameter may prevent eavesdroppers monitoring the network to track down STAs undergoing address rotation.

In a variety of embodiments, the process 500 may determine a historical count of network devices that participated in the address rotation within a historical time interval (block 530). In numerous embodiments, the historical time interval may be prior to the identified one or more upcoming time intervals. For example, some STAs may have opted to participate in address rotation at the historical time interval but failed to change their addresses at the historical time interval, while other STAs may not have opted but still rotated their address at the historical time interval. Such determination may be required to determine an actual count of network devices that changed their addresses within the historical time interval.

In more embodiments, the process 500 may generate a message indicating the one or more upcoming time intervals and one or more of the threshold counts associated with the one or more upcoming time intervals, the historical count of network devices, a flag, or a start time for at least one of the one or more upcoming time intervals (block 540). The flag may be included in the message to indicate whether a threshold count set for the historical time interval was reached or not. For example, if the threshold count set for the historical time interval was ‘10’ and the historical count of network devices that rotated (e.g., changed) their addresses was ‘12’, the flag can have a first value indicating that threshold count was reached (e.g., satisfied) in the historical time interval. However, if only ‘8’ network devices changed their address at the historical time interval, the flag can have a second value indicating that the threshold count was not reached (e.g., satisfied) in the historical time interval. By indicating, in the message, whether the threshold count was reached in the historical time interval, the process 500 may indirectly indicate a likelihood of the threshold count being satisfied within an upcoming time interval as well. By disseminating this comprehensive information in the message, the process 500 may enable the STAs to choose an upcoming time interval for address rotation that can provide the best crowd obfuscation parameter and satisfy the requirements of the STAs.

In additional embodiments, the process 500 may encrypt the message (block 550). Encrypting the message before broadcasting may ensure that only STAs connected to the network can access the message, protecting the STAs from eavesdroppers monitoring the network. The encryption process may use a secure encryption algorithm to encode the message, making it unreadable by any STA that does not have a decryption key associated with the encryption algorithm. As a result, only STAs connected to the network can decrypt and read the message, ensuring that sensitive information remains confidential and secure, thereby enhancing the overall integrity and privacy of the address rotation of the STAs.

In further embodiments, the process 500 may broadcast the message (block 560). In several embodiments, the message can be broadcasted at specific time periods. The specific time periods can be periodic time intervals or random time intervals. By broadcasting the message at specific time periods, the process 500 may ensure that the connected STAs are informed and prepared for an upcoming address rotation in an upcoming time interval of the one or more upcoming time intervals. The message can be broadcasted via a management frame, an announcement frame, a beacon, or the like.

Although a specific embodiment for broadcasting a message for coordinating device address rotation suitable for carrying out the various steps, processes, methods, and operations described herein is discussed with respect to FIG. 5, any of a variety of systems and/or processes may be utilized in accordance with embodiments of the disclosure. For example, in numerous additional embodiments, the process 500 can control a frequency of re-broadcasting the message based on whether the threshold count is satisfied or not for the earliest upcoming time interval. The elements depicted in FIG. 5 may also be interchangeable with other elements of FIGS. 1-4 and 6-11 as required to realize a particularly desired embodiment.

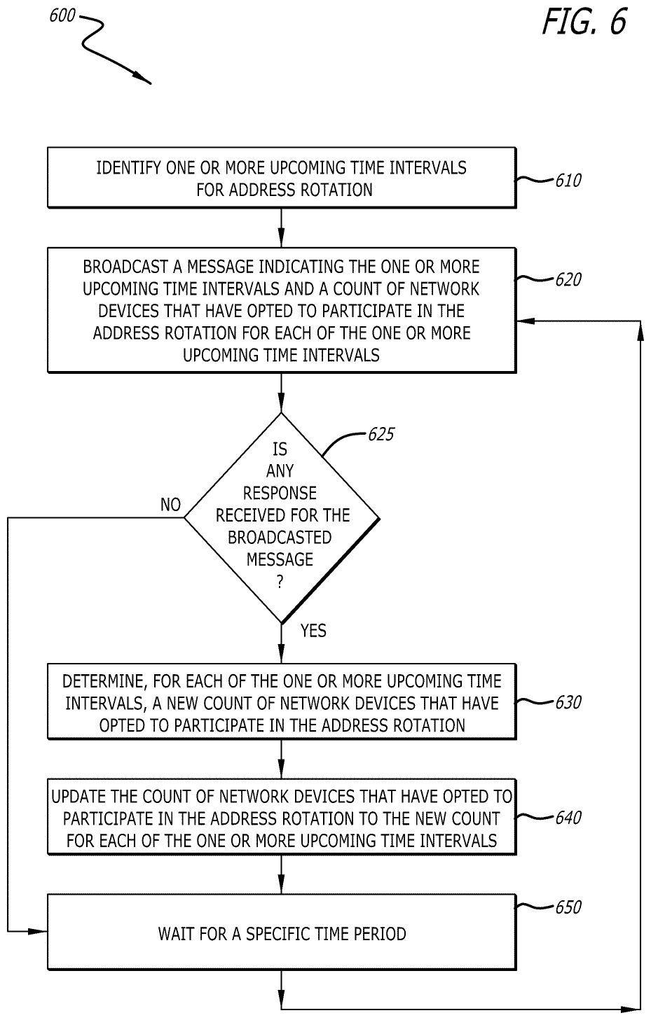

Referring to FIG. 6, a flowchart showing a process 600 for facilitating device address rotation in accordance with various embodiments of the disclosure is shown. In many embodiments, the process 600 may identify one or more upcoming time intervals for address rotation (block 610). The one or more upcoming time intervals may refer to specific future time intervals during which address rotation of any of a plurality of network devices (interchangeably referred to as “STAs”) can occur. This involves determining precise time frames at which a group of STAs can change their MAC addresses at the same time to enhance network privacy and security. For example, the one or more upcoming time intervals may be scheduled every hour at the 30-minute mark (e.g., ‘1:30 PM’, ‘2:30 PM’, ‘3:30 PM’, . . . , and ‘12:30 AM’). In further examples, the process 600 may identify only one upcoming time interval at a time.

In a number of embodiments, the process 600 may broadcast a message indicating the one or more upcoming time intervals and a count of network devices that have opted to participate in the address rotation for each of the one or more upcoming time intervals (block 620). The message may be broadcasted to all STAs connected to the network, informing the STAs of the identified upcoming time intervals for the address rotation and the count of other STAs that have selected to change their addresses at those upcoming time intervals. Thus, enabling the STAs to select an upcoming time interval to change their addresses in co-ordination with other STAs that have selected the same upcoming time interval. Including the count of network devices that have already opted to participate in the address rotation for each of the one or more upcoming time intervals may enable an STA to decide whether to join the address rotation based on the count of participating peers. In a non-limiting example, the message may indicate that address rotations will occur at ‘1:30 PM’, ‘2:30 PM’, and ‘3:30 PM’. The message may further indicate that ‘5’ STAs have already opted to participate in address rotation at ‘1:30 PM’, ‘3’ STAs for ‘2:30 PM’ rotation, and ‘7’ STAs for ‘3:30 PM’.

In more embodiments, the process 600 may determine whether any response is received for the broadcasted message (block 625). In a variety of embodiments, the process 600 may receive a response from at least one STA. The response may refer to an action frame that indicates whether the at least one STA intends to participate in the address rotation within any of the one or more upcoming time intervals. In many examples, the at least one STA can send a response to participate in the address rotation within any of the one or more upcoming time intervals. In further examples, the at least one STA can also send a response to opt out of participating in the address rotation in the one or more upcoming time intervals. For example, a ‘Device A’ transmits a response with an intention to participate in ‘1:30 PM’ address rotation, while another ‘Device B’ transmits a response with an intention to join the ‘2:30 PM’ address rotation. Further, a ‘Device C’ may transmit a response with an intention to not participate in the ‘3:30 PM’ address rotation.

If at least one response is received, in additional embodiments, the process 600 may determine, for each of the one or more upcoming time intervals, a new count of network devices that have opted to participate in the address rotation (block 630). In yet more embodiments, the process 600 may determine whether the response indicates an intent to participate in the address rotation or an intent to be released from an address rotation pool. The address rotation pool may correspond to a group of STAs that have opted in to participate in address rotation within a specific upcoming time interval. Further, the new count may be determined for each of the one or more upcoming time intervals based on whether the response indicates an intent to participate in the address rotation or an intent to be released from an address rotation pool. For example, based on the response of ‘Device A’ indicating an intent to participate in the ‘1:30 PM’ address rotation, the device count for the ‘1:30 PM’ address rotation is increased from ‘5’ to ‘6’. Likewise, based on the response of ‘Device B’ indicating an intent to participate in the ‘2:30 PM’ address rotation, the device count for the ‘2:30 PM’ address rotation is increased from ‘3’ to ‘4’. However, if the ‘Device C’ had initially opted in to participate in the ‘3:30 PM’ address rotation and later withdrew from the address rotation pool by transmitting the response to the broadcasted message, the device count for the ‘3:30 PM’ address rotation may now be reduced from ‘7’ to ‘6’.

In further embodiments, the process 600 may update the count of network devices that have opted to participate in the address rotation to the new count for each of the one or more upcoming time intervals (block 640). In other words, the count of the network devices that have opted to participate in the address rotation is updated to reflect the new count of network devices. For example, the device count for the ‘1:30 PM’ address rotation is updated to ‘6’ devices, the device count for the ‘2:30 PM’ address rotation is updated to ‘4’ devices, and the device count for the ‘3:30 PM’ address rotation is updated to ‘6’ devices, in the message.

In still more embodiments the process 600 may wait for a specific time period (block 650). In other words, the process 600 may wait for the specific time period set for re-broadcasting the message. The waiting period may allow additional time for more STAs to decide on their participation for address rotation. For example, the process 600 may wait for ‘15’ minutes to allow more STAs to decide and respond to the broadcasted message. After the specific time period is over, the process 600 may broadcast an updated message with the new count of network devices. In still additional embodiments, if no response is received for the broadcasted message, the process 600 may wait for the specific time period before re-broadcasting the message (block 650).

Although a specific embodiment for facilitating device address rotation suitable for carrying out the various steps, processes, methods, and operations described herein is discussed with respect to FIG. 6, any of a variety of systems and/or processes may be utilized in accordance with embodiments of the disclosure. For example, in several more embodiments, the process 600 may receive encrypted responses from STAs. The elements depicted in FIG. 6 may also be interchangeable with other elements of FIGS. 1-5 and 7-11 as required to realize a particularly desired embodiment.

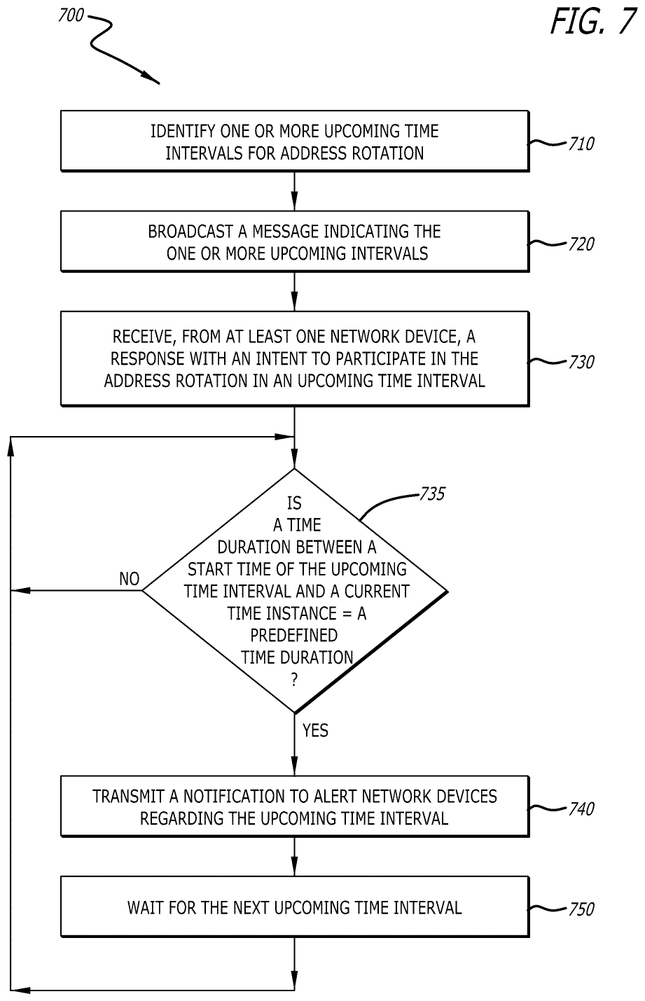

Referring to FIG. 7, a flowchart showing a process 700 for facilitating device address rotation in accordance with various embodiments of the disclosure is shown. In many embodiments, the process 700 may identify one or more upcoming time intervals for address rotation (block 710). The one or more upcoming time intervals may include time schedules at which a plurality of network devices (interchangeably referred to as “STAs”) connected to a network can select to undergo a coordinated address rotation. In an example, the process 700 can be performed by an AP communicatively coupled to the plurality of STAs. The one or more upcoming time intervals may include, for example, epoch boundaries at which address rotation can happen. The plurality of STAs may select any of the one or more upcoming time intervals for performing address rotation, for example, MAC address rotation, IP address rotation, or any other suitable identifier rotation. Examples of the plurality of STAs may include, but are not limited to, smartphones, laptops, tablets, smartwatches, smart appliances, wearable devices, IoT devices, or the like. In a non-limiting example, the message may indicate that address rotations will occur at upcoming time intervals ‘1:30 PM’, ‘2:30 PM’, and ‘3:30 PM’.

In a number of embodiments, the process 700 may broadcast a message indicating the one or more upcoming time intervals (block 720). The message can be broadcasted via a management frame, an announcement frame, a beacon, or the like. The message may be broadcasted to notify the plurality of STAs about future time schedules for address rotation (for example, MAC address rotation). For example, an STA connected to the network, upon receiving broadcasted message, may decide to perform address rotation within any of the upcoming time intervals ‘1:30 PM’, ‘2:30 PM’, or ‘3:30 PM’.

In a variety of embodiments, the process 700 may receive, from at least one network device (e.g., STA) a response with an intent to participate in the address rotation in an upcoming time interval of the one or more upcoming time intervals (block 730). In other words, the at least one STA may transmit a response for participating in the address rotation within the upcoming time interval. For example, a ‘Device A’ may respond with an intention to participate in ‘1:30 PM’ address rotation, while another ‘Device B’ may respond with an intention to join ‘2:30 PM’ address rotation.

In more embodiments, the process 700 may determine whether a time duration between a start time of the upcoming time interval and a current time instance is equal to a predefined time duration (block 735). The process 700 may perform this check to ensure that STAs in the network receive a timely reminder about the upcoming address rotation. The process 700 may monitor the current time and compare it with the start time of the upcoming time interval. For example, the predefined time duration may be set to ‘10’ minutes. Thus, if the upcoming time interval is scheduled for ‘2:30 PM’, the process 700 may determine whether the current time is ‘10’ minutes to ‘2:30 PM’ (i.e., ‘2:20 PM’). At ‘2 PM’, the condition may not be satisfied as it is still ‘30’ minutes to ‘2:30 PM’. Again at ‘2:10 PM’, the condition may not be met. However, when the current time instance is ‘2:20 PM’, the process 700 may determine that the predefined time duration condition is satisfied.

If the time duration between the start time of the upcoming time interval and the current time instance is not equal to the predefined time duration, the process 700 may continue to monitor the current time instance until the predefined time duration condition is satisfied (block 735). However, if the time duration between the start time of the upcoming time interval and the current time instance is equal to the predefined time duration, in further embodiments, the process 700 may transmit a notification to alert network devices regarding the upcoming time interval (block 740). In other words, if the predefined time duration condition is satisfied, the process 700 may broadcast the notification to alert the STAs about the address rotation at ‘2:30 PM’. This may ensure that the STAs are adequately reminded and can prepare for an upcoming address rotation event.

In still more embodiments the process 700 may wait for the next upcoming time interval (block 750). For example, after the ‘2:30 PM’ time interval, the process 700 may start checking for the next upcoming time interval, e.g., ‘3:30 PM’, and repeat the process of determining if the time duration between the start time of the upcoming time interval and the current time instance is equal to the predefined time duration. That is to say, the process 700 may check whether the current time is exactly ‘10’ minutes to ‘3:30 PM’, i.e., ‘3:20 PM’

Although a specific embodiment for facilitating device address rotation suitable for carrying out the various steps, processes, methods, and operations described herein is discussed with respect to FIG. 7, any of a variety of systems and/or processes may be utilized in accordance with embodiments of the disclosure. For example, in further additional embodiments, instead of broadcasting the notification, the process 700 may transmit the notification to only those STAs that have opted to participate in the address rotation within the upcoming time interval. The elements depicted in FIG. 7 may also be interchangeable with other elements of FIGS. 1-6 and 8-11 as required to realize a particularly desired embodiment.

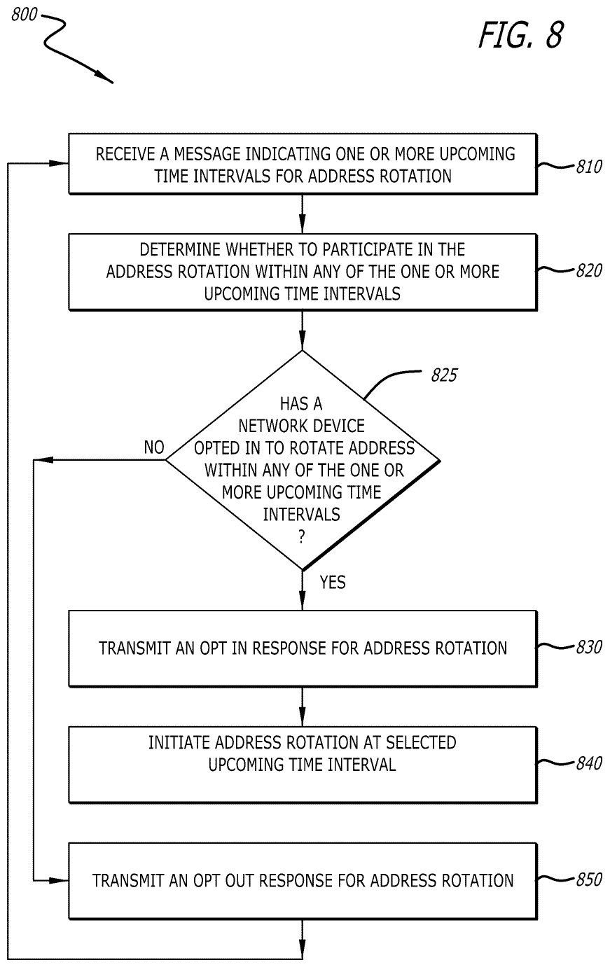

Referring to FIG. 8, a flowchart showing a process 800 for device address rotation in accordance with various embodiments of the disclosure is shown. The process 800 may be performed by a network device (e.g., an STA) connected to a network. In many embodiments, the process 800 may receive a message indicating one or more upcoming time intervals for address rotation (block 810). In numerous embodiments, the message may have been broadcasted by an AP to indicate the one or more upcoming time intervals scheduled for the address rotation, for example, MAC rotation. In other words, the message may indicate various details regarding the next address rotation events. Examples of the STA may include, but are not limited to, smartphones, laptops, tablets, smartwatches, smart appliances, wearable devices, IoT devices, or the like. In a non-limiting example, the STA (e.g., a laptop) connected to the network may receive a message from the AP stating that the next address rotations will occur at ‘1:30 PM’, ‘2:30 PM’, and ‘3:30 PM’.

In a number of embodiments, the process 800 may determine whether to participate in the address rotation within any of the one or more upcoming time intervals (block 820). Upon receiving the message, the STA may assess whether the STA should participate in the address rotation in any of the upcoming time intervals. This decision might be based on internal policies, current activity levels, or user settings of the STA. For example, the laptop may evaluate its current status, such as but not limited to whether the laptop is actively transferring data or is idle, whether any privacy feature requires MAC address change, or the like, and determine if address rotation is required within any of the one or more upcoming time intervals indicated by the received message. In further embodiments, if it is determined that address rotation is required, the process 800 may be configured to select an upcoming time interval from the one or more upcoming time intervals based on a count of network devices that have opted for address rotation within the upcoming time interval. In other words, the STA may have set its criteria for how many other STAs need to be involved in the address rotation for the STA to participate. For example, in the received message, the upcoming time interval that is indicated to have the maximum count of network devices participating in the address rotation may be selected as the upcoming time interval for address rotation by the process 800.

In a variety of embodiments, the process 800 may determine whether the network device has opted to change address within any of the one or more upcoming time intervals (block 825). In other words, the process 800 may perform a check to determine whether the STA has decided to participate in the address rotation at any of the one or more upcoming time intervals indicated by the received message.

If the STA has opted to change its address within any of the one or more upcoming time intervals, in more embodiments, the process 800 may transmit an opt in response for address rotation (block 830). In numerous additional embodiments, the process 800 may unicast the response to the AP that had broadcasted the message. For example, the broadcasted message may include an identifier of the AP. The process 800 may identify the AP based on the identifier and accordingly unicast the response to the AP. In further additional embodiments, the process 800 may broadcast the response. In order to maintain privacy and security during broadcast, the process 800 may encrypt the response prior to transmitting. The response may be configured to indicate that the STA will rotate its MAC address at one of the upcoming time intervals. The STA may transmit the response via an opt in action frame. For example, the laptop may transmit a response to the AP confirming its participation in the address rotation scheduled for ‘1:30 PM’. In several embodiments, the response may include a current MAC address or another unique identifier of the STA along with the selected upcoming time interval, for example, ‘1:30 PM’.

In still more embodiments, the process 800 may initiate address rotation at the selected upcoming time interval (block 840). In other words, when the selected time interval arrives, the STA may change its MAC address as planned. This MAC address randomization may depend on the type of the STA as well as the type of network. Such MAC address rotation may ensure that the identity of the STA is periodically refreshed, enhancing privacy. For example, at ‘1:30 PM’, the laptop changes its MAC address to a new MAC address, ensuring that network activities of the STA are less traceable.

If the network device does not opt to rotate its address within any of the one or more upcoming time intervals, in additional embodiments, the process 800 may transmit an opt out response for address rotation (block 850). This indicates that the STA will not be changing its MAC address within the upcoming time intervals and may decide to wait for the next message from the AP regarding future time intervals. The STA may transmit the response to the AP via an opt out action frame. For example, the laptop may transmit an opt out response to the AP indicating that the laptop will not participate in any of the upcoming address rotations indicated by the message broadcasted by the AP. In several additional embodiments, the process 800 may transmit the opt out response to withdraw or be released from an address rotation pool, the process 800 had previously opted in.

Although a specific embodiment for address rotation suitable for carrying out the various steps, processes, methods, and operations described herein is discussed with respect to FIG. 8, any of a variety of systems and/or processes may be utilized in accordance with embodiments of the disclosure. For example, the process 800 can initiate address rotation in any of the upcoming time intervals indicated by the message even if the STA had transmitted an opt out response previously. In still further embodiments, the process 800 may perform the address rotation earlier than the prescribed upcoming time interval. In such a scenario, the process 800 may transmit a response frame to the AP that had broadcasted the message for address rotation. The response frame may include an announce bit configured to indicate that the address (e.g., MAC address) of the STA is rotated prior to the prescribed or selected upcoming time interval by a predefined time. The elements depicted in FIG. 8 may also be interchangeable with other elements of FIGS. 1-7 and 9-11 as required to realize a particularly desired embodiment.

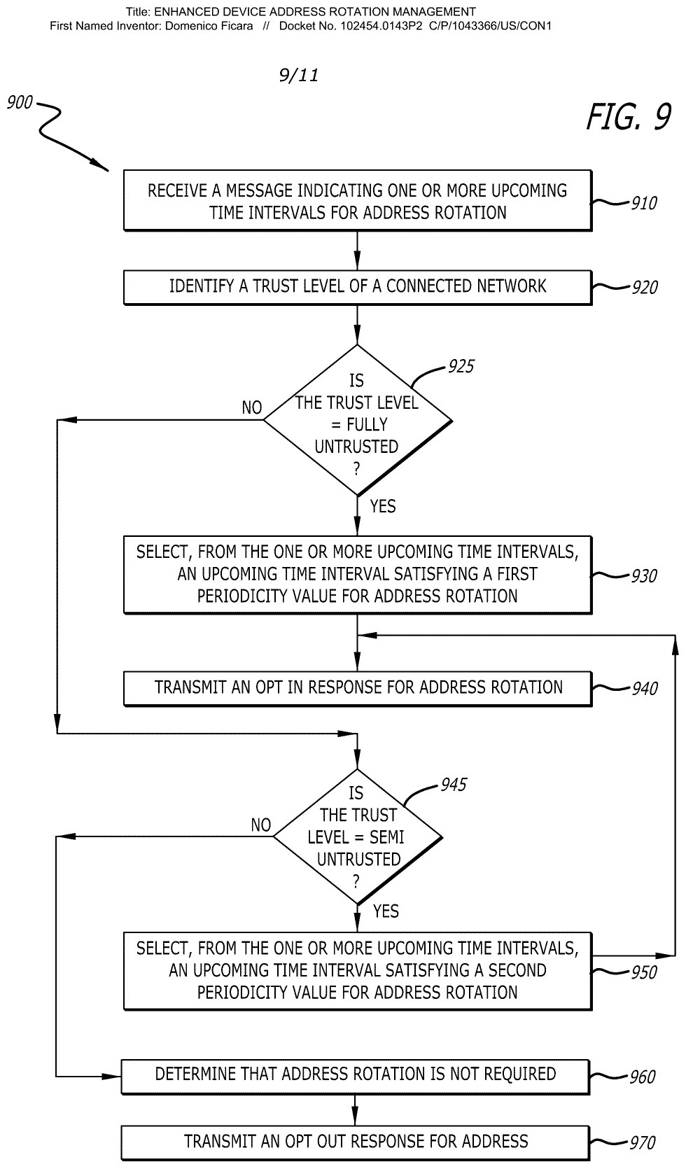

Referring to FIG. 9, a flowchart showing a process 900 for trust-based address rotation in a wireless device in accordance with various embodiments of the disclosure is shown. In many embodiments, the process 900 may receive a message indicating one or more upcoming time intervals for address rotation (block 910). The message may be broadcasted by an AP deployed to provide assistance for address rotation to a plurality of STAs (interchangeably referred to as network devices) connected to a network.

In a variety of embodiments, the process 900 may identify a trust level of a connected network (block 920). Different trust levels may include, for example, a fully-untrusted level, a semi-untrusted level, a fully-trusted level, or the like. In additional embodiments, the process 900 may identify the trust level of the connected network based on, for example, SSID and the Authentication and Key Management (AKM) protocol utilized by the connected network. For example, the connected network can be identified as fully untrusted if the SSID of the connected network is broadcasted and discoverable by any nearby devices and the AKM protocol utilized by the connected network is weak or outdated, providing little to no encryption or authentication. Similarly, the connected network can be identified as semi untrusted if the SSID is broadcasted and discoverable by any nearby devices and the AKM protocol involves stronger encryption standards, providing a moderate level of security against unauthorized access. Further, the connected network can be identified as fully trusted if the SSID is not broadcasted publicly, requiring devices to enter network details or use advanced discovery methods and the AKM protocol involves stronger encryption and authentication standards. In further embodiments, the process 900 may treat the connected network as fully untrusted if the connected network is a Passpoint network (e.g., Hotspot 2.0). For example, the process 900 may treat the network as fully untrusted if the STA connects to a Wi-Fi network automatically without having to manually search for and authenticate with the network.

In several embodiments, the process 900 may utilize predefined criteria, such as a network trust level, or the like, to select a most suitable upcoming time interval for address rotation. In several more embodiments, different network trust levels may be associated with different address rotation requirements. In an example, a Fully Untrusted Open/Opportunistic Wireless Encryption (OWE) network may require address rotation every ‘5’ minutes, a Semi Untrusted Private Shared Key (PSK) network may require address rotation every ‘10’ minutes, and a Trusted 802.1X may not require address rotation by default. In several additional embodiments, the process 900 may have a capability to define or update a default trust level of the connected network based on the SSID and AKM.

In a number of embodiments, the process 900 may determine whether the trust level is fully untrusted (block 925). For example, the process 900 may determine that the STA is connected to a public Wi-Fi network which is fully untrusted. If the trust level is identified as fully untrusted, in more embodiments, the process 900 may select, from the one or more upcoming time intervals, an upcoming time interval satisfying a first periodicity value for address rotation (block 930). The first periodicity value may be defined or set for the fully untrusted networks. In an example, the first periodicity value may be set to ‘10’ minutes. Thus, if the connected network is fully untrusted, the process 900 may select an upcoming time interval, from the one or more upcoming time intervals, which aligns with the 10-minute periodicity value from the previous address rotation event. In other words, if the previous address rotation had occurred at ‘10:00 AM’ and the one or more upcoming time intervals include ‘10:02 AM’, ‘10:05 AM’, ‘10:10 AM’, and ‘10:15 AM’, the process 900 may select ‘10:10 AM’ time interval satisfying the 10-minute periodicity value. Since probing for “known networks” can inadvertently expose device's history and compromise user privacy, the process 900 may refrain from probing for “known networks” when connected to a fully untrusted network. In other words, the process 900 may refrain from actively searching for and identifying previously connected networks. Further, the process 900 may avoid sending Bonjour requests for service discovery within local networks.

In yet additional embodiments, the process 900 may transmit an opt in response for address rotation (block 940). In other words, the process 900 may transmit the opt in response to the AP indicating its intention to participate in the address rotation at the selected upcoming time interval. In many additional embodiments, the opt in response can include more than one selected upcoming time interval, each satisfying the first periodicity value.

However, if the trust level is not determined to be fully untrusted, in still more embodiments, the process 900 may determine whether the trust level is semi untrusted (block 945). If the connected network is semi-untrusted, in still further embodiments, the process 900 may select, from the one or more upcoming time intervals, an upcoming time interval satisfying a second periodicity value for address rotation (block 950). The second periodicity value may be defined or set for the semi untrusted networks. In an example, the second periodicity value may be set to ‘5’ minutes. Thus, if the connected network is semi untrusted, the process 900 may select an upcoming time interval, from the one or more upcoming time intervals, which aligns with the 5-minute periodicity value from the previous address rotation event. In other words, if the previous address rotation had occurred at ‘10:00 AM’ and the one or more upcoming time intervals include ‘10:02 AM’, ‘10:05 AM’, ‘10:10 AM’, and ‘10:15 AM’, the process 900 may select at least ‘10:05 AM’ time interval satisfying the 5-minute periodicity value. Further, the process 900 may refrain from probing for “known networks” when connected to semi untrusted network. The process 900 may then transmit an opt in response for address rotation (block 940).

However, if the trust level is not even semi-trusted, the trust level is identified as fully trusted. Hence, in still additional embodiments, the process 900 may determine that address rotation is not required (block 960). In yet more embodiments, the process 900 may transmit an opt out response for address rotation (block 970). In other words, in response to determining that the network is completely trusted, the process 900 can choose not to participate in the address rotation. Such an approach may help in reducing unnecessary overhead and complexity when connected to secure and reliable networks.

Although a specific embodiment for trust-based address rotation suitable for carrying out the various steps, processes, methods, and operations described herein is discussed with respect to FIG. 9, any of a variety of systems and/or processes may be utilized in accordance with embodiments of the disclosure. For example, in still yet more embodiments, if information resource management (IRM) is detected to be in use at the STA, the process 900 may rotate the address in accordance with the first periodicity value even if the trust level is semi untrusted or fully trusted. The elements depicted in FIG. 9 may also be interchangeable with other elements of FIGS. 1-8, 10, and 11 as required to realize a particularly desired embodiment.

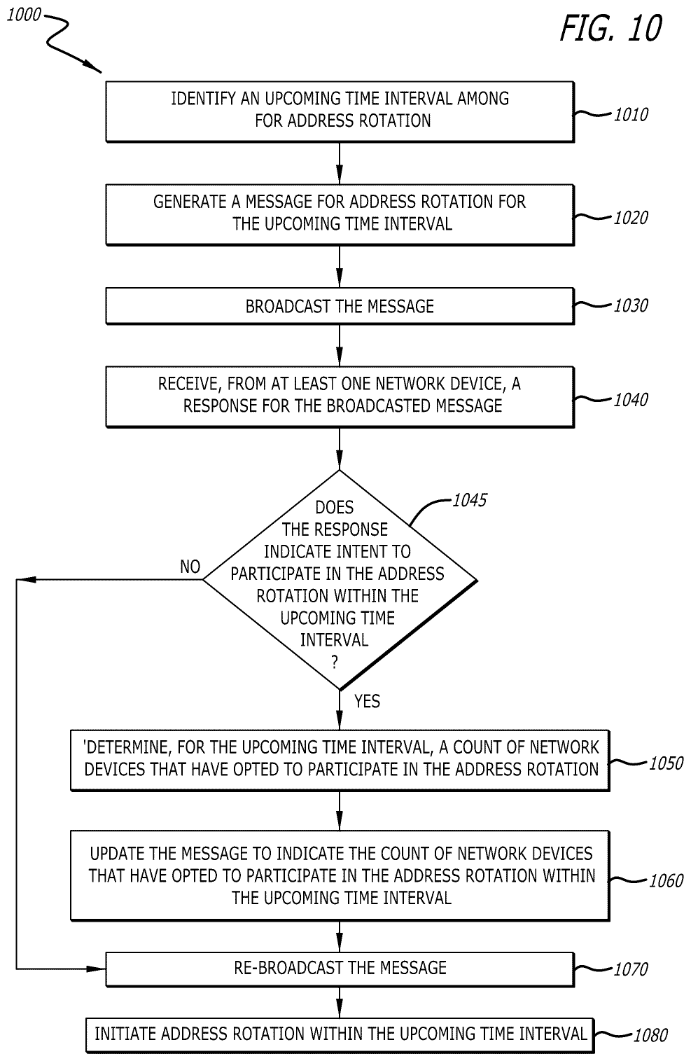

Referring to FIG. 10, a flowchart showing a process 1000 for coordinating device address rotation in accordance with various embodiments of the disclosure is shown. In many embodiments, the process 1000 may identify an upcoming time interval for address rotation (block 1010). In several embodiments, a trust level of the network may be fully untrusted or semi untrusted and an STA may not trust a connected AP for coordinating address rotation. In such embodiments, the process 1000 for coordinating device address rotation may be executed at an STA without AP coordination. The STA may assume the role of a leader STA for coordinating device address rotation. In several more embodiments, the process 1000 may identify the upcoming time interval for address rotation based on one or more privacy and security requirement of the leader STA, for privacy policies, current activity levels, network trust levels, user settings of the leader STA, or the like.

In a variety of embodiments, the process 1000 may generate a message for address rotation for the upcoming time interval (block 1020). In other words, in response to identifying the upcoming time interval, the process 1000 may generate the message that includes the details of the identified upcoming time interval. For example, if the leader STA is scheduled to rotate its MAC address at the upcoming time interval, the leader STA may generate an address rotation announcement (e.g., the message) to prompt other STAs connected to the same network (e.g., sharing the same BSSID) to change their addresses within the upcoming time interval.

In a number of embodiments, the process 1000 may broadcast the message (block 1030). In other words, the generated message is broadcasted to prompt other connected STAs within the network for address rotation. This broadcast serves as an announcement to other STAs about an upcoming address rotation event within the upcoming time interval. Thus, if the upcoming time interval is at ‘2:00 PM’, the process 1000 may broadcast the prior to ‘2:00 PM’. Other STAs upon receiving the broadcasted message may determine whether to participate in the upcoming address rotation event. Accordingly, one or more other STAs may transmit responses to the leader STA.

In more embodiments, the process 1000 may receive, from at least one network device (e.g., another STA), a response for the broadcasted message (block 1040). In other words, after broadcasting the message, the process 1000 may wait to receive responses from other STAs. In numerous embodiments, the at least one STA may transmit a response to indicate its intent to participate in the address rotation. In numerous additional embodiments, the at least one STA can also respond with an opt out response indicating its intent to skip address rotation in the upcoming time interval.

In additional embodiments, the process 1000 may determine whether the response indicates an intent to participate in the address rotation within the upcoming time interval (block 1045). In further embodiments, the response may include an action bit configured to indicate whether the at least one STA intends to participate in the address rotation or not. For example, the action bit having a first value may indicate an intent to participate in the address rotation, while the action bit having a second value may indicate an intent to skip the address rotation.

If the response indicates an intent to participate, in many further embodiments, the process 1000 may determine, for the upcoming time interval, a count of network devices that have opted to participate in the address rotation (block 1050). For instance, if ‘10’ other STAs have opted to participate in the address rotation within the upcoming time interval, the count is determined to be ‘10’.

In further additional embodiments, the process 1000 may update the message to indicate the count of network devices that have opted to participate in the address rotation within the upcoming time interval (block 1060). For example, the process 1000 may include a new field in the generated message to reflect the count of network devices participating in the address rotation within the upcoming time interval. This count of network devices opting to participate in the address rotation within the upcoming time interval may serve as a crowd obfuscation parameter that provides an indication to other STAs of how well they can “hide in the crowd” if they opt to perform address rotation within the upcoming time interval.

In still further embodiments, the process 1000 may re-broadcast the message (block 1070). For example, the process 1000 may wait for a specific time period before re-broadcasting the message with the count of network devices. Moreover, if the response of the at least one STA indicates no intent to participate (block 1045), the process 1000 may wait for the specific time period and re-broadcast the message without indicating the count of network devices (block 1070).

In still more embodiments, the process 1000 may initiate address rotation within the upcoming time interval (block 1080). In other words, the process 1000 may initiate address rotation at the designated time interval. Other STAs that had opted in may also rotate their addresses (e.g., MAC addresses). However, there may be a few STAs that may not rotate their MAC address at the designated time interval even though they had opted for participating in the address rotation. Further, there may be a few STAs that rotate their MAC addresses at the designated time interval in spite of opting out of the address rotation at the designated time interval.

Although a specific embodiment for coordinating device address rotation suitable for carrying out the various steps, processes, methods, and operations described herein is discussed with respect to FIG. 10, any of a variety of systems and/or processes may be utilized in accordance with embodiments of the disclosure. For example, in yet more embodiments, the process 1000 may determine a minimum count of devices that need to participate in the address rotation. The broadcasted message can also indicate the minimum count. In a scenario, where the minimum count is not satisfied, the process 1000 may delay the address rotation and inform the participating STAs. The participating STAs can either wait or continue changing their addresses as per the original designated time interval. The elements depicted in FIG. 10 may also be interchangeable with other elements of FIGS. 1-9 and 11 as required to realize a particularly desired embodiment.

Referring to FIG. 11, a conceptual block diagram of a device 1100 suitable for configuration with an address rotation logic in accordance with various embodiments of the disclosure is shown. The embodiment of the conceptual block diagram depicted in FIG. 11 can illustrate a conventional server, switch, wireless LAN controller, access point, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 11 can also illustrate an access point, a switch, or a router in accordance with various embodiments of the disclosure. The device 1100 may, in many non-limiting examples, correspond to physical devices or virtual resources described herein.

In many embodiments, the device 1100 may include an environment 1102 such as a baseboard or “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In more embodiments, one or more processors 1104, such as, but not limited to, central processing units (“CPUs”) can be configured to operate in conjunction with a chipset 1106. The processor(s) 1104 can be standard programmable CPUs that perform arithmetic and logical operations necessary for the operation of the device 1100.

In a number of embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The chipset 1106 can provide an interface to a random-access memory (“RAM”) 1108, which can be used as the main memory in the device 1100 in some embodiments. The chipset 1106 can further be configured to provide an interface to a computer-readable storage medium such as a read-only memory (“ROM”) 1110 or non-volatile RAM (“NVRAM”) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Additional embodiments of the device 1100 can be configured to operate in a networked environment using logical connections to remote computing devices and computer systems through a network, such as the network 1140. The chipset 1106 can include functionality for providing network connectivity through a network interface card (“NIC”) 1112, which may comprise a gigabit Ethernet adapter or similar component. The NIC 1112 can be capable of connecting the device 1100 to other devices over the network 1140. It is contemplated that multiple NICs 1112 may be present in the device 1100, connecting the device to other types of networks and remote systems.

In further embodiments, the device 1100 can be connected to a storage 1118 that provides non-volatile storage for data accessible by the device 1100. The storage 1118 can, for instance, store an operating system 1120 and applications 1122. The storage 1118 can be connected to the environment 1102 through a storage controller 1114 connected to the chipset 1106. In certain embodiments, the storage 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1100 can store data within the storage 1118 by transforming the physical state of the physical storage units to reflect the information being stored. The specific transformation of physical state can depend on various factors. Examples of such factors can include, but are not limited to, the technology used to implement the physical storage units, whether the storage 1118 is characterized as primary or secondary storage, and the like.

In many more embodiments, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 1118 by detecting the physical states or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, and or any components included therein, may be supported by one or more devices similar to device 1100. Stated otherwise, some or all of the operations performed by the cloud computing network, and or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device 1100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1118 can store other system or application programs and data utilized by the device 1100.

In many additional embodiments, the storage 1118 or other computer-readable storage media is encoded with computer-executable instructions which, when loaded into the device 1100, may transform it from a general-purpose computing system into a special-purpose computer capable of implementing the embodiments described herein. These computer-executable instructions may be stored as application 1122 and transform the device 1100 by specifying how the processor(s) 1104 can transition between states, as described above. In some embodiments, the device 1100 has access to computer-readable storage media storing computer-executable instructions which, when executed by the device 1100, perform the various processes described above with regard to FIGS. 1-10. In certain embodiments, the device 1100 can also include computer-readable storage media having instructions stored thereupon for performing any of the other computer-implemented operations described herein.

In many further embodiments, the device 1100 may include an address rotation logic 1124. The address rotation logic 1124 can be configured to perform one or more of the various steps, processes, operations, and/or other methods that are described above. Often, the address rotation logic 1124 can be a set of instructions stored within a non-volatile memory that, when executed by the processor(s)/controller(s) 1104 can carry out these steps, etc. In some embodiments, the address rotation logic 1124 may be a client application that resides on a network-connected device, such as, but not limited to, a server, switch, personal or mobile computing device in a single or distributed arrangement. The address rotation logic 1124 may be configured to identify one or more upcoming time intervals for address rotation. The address rotation logic 1124 may set a threshold count on a minimum number of network devices that have to participate in the address rotation. The address rotation logic 1124 may further determine a historical count of network devices that participated in the address rotation within a historical time interval. The address rotation logic 1124 may further generate a message indicating the one or more upcoming time intervals and one or more of the threshold counts, the historical count of network devices, a flag, or a start time for at least one of the one or more upcoming time intervals The address rotation logic 1124 may be further configured to encrypt the message such that the contents of the message are not leaked to an eavesdropper. The address rotation logic 1124 may broadcast the message in the network to inform a schedule of address rotation. The message can be broadcasted by the address rotation logic 1124 at specific time periods.

The address rotation logic 1124 may be further configured to receive, from at least one network device, a response for the broadcasted message. The response may be configured to indicate whether the at least one network device intends to participate in the address rotation within at least one of the one or more upcoming time intervals. For example, the response may be configured to indicate that the at least one network device intends to opt in or opt out from participating in the address rotation within the at least one of the one or more upcoming time intervals. Based on the responses received, the address rotation logic 1124 may determine a count of network devices that have opted to participate in the address rotation and may include the count in the updated message. The address rotation logic 1124 may rebroadcast the updated message after a specific time period.

In some embodiments, the storage 1118 can include address data 1128. The address data 1128 can encompass various identifiers associated with network devices (e.g., STAs) in the network. For example, the address data 1128 may include MAC addresses assigned to the network devices in the network. The address data 1128 may be updated after every address rotation event to include new addresses of the network devices.

In various embodiments, the storage 1118 can include time interval data 1130. The time interval data 1130 may include information about upcoming time intervals, specific time periods, or the like for address rotations. The upcoming time interval may include information about epoch boundaries within which one or more network devices perform address rotation. The specific time periods may include the periodic intervals of time at which the message is re-broadcasted by the address rotation logic 1124. Further, the time interval data 1130 may include a start time of each upcoming time interval that indicates when a particular time interval may start.

In a number of embodiments, the storage 1118 can include threshold count data 1132. The threshold count data 1132 may comprise detailed information about a minimum number of network devices that have to participate in the address rotation. Each upcoming time interval may be associated with a threshold count that would indicate a sufficient number of network devices rotating their MAC addresses at the same time, to make “hiding in the crowd” effective. The threshold count data 1132 may also be referred to as the crowd obfuscation parameter that represents the density of network devices rotating MAC addresses at the same time.

In still further embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 might not include all of the components shown in FIG. 11 and can include other components that are not explicitly shown in FIG. 11 or might utilize an architecture completely different than that shown in FIG. 11.

As described above, the device 1100 may support a virtualization layer, such as one or more virtual resources executing on the device 1100. In some examples, the virtualization layer may be supported by a hypervisor that provides one or more virtual machines running on the device 1100 to perform functions described herein. The virtualization layer may generally support a virtual resource that performs at least a portion of the techniques described herein.

Finally, in numerous additional embodiments, data may be processed into a format usable by a machine-learning model 1126 (e.g., feature vectors), and or other pre-processing techniques. The machine-learning (“ML”) model 1126 may be any type of ML model, such as supervised models, reinforcement models, and/or unsupervised models. The ML model 1126 may include one or more of linear regression models, logistic regression models, decision trees, Naïve Bayes models, neural networks, k-means cluster models, random forest models, and/or other types of ML models 1126.

The ML model(s) 1126 can be configured to generate inferences to make predictions or draw conclusions from data. An inference can be considered the output of a process of applying a model to new data. This can occur by learning from at least the address data 1128, the time interval data 1130, and the threshold count data 1132. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1126 may be generated by human/administrator verifications or may compare predicted outcomes with actual outcomes. In several embodiments, the ML model(s) 1126 may be configured to determine the threshold count data 1132 based on historical address rotation events. Further, the ML model(s) 1126 may be configured to identify the one or more upcoming time intervals for address rotations based on the historical address rotation events. For example, the ML model(s) 1126 may examine historical address rotation data to identify patterns or trends. By learning from historical address rotation events when the threshold count was satisfied, the ML model(s) 1126 can predict future time intervals with a high probability of satisfying the threshold count. In other words, once trained, the ML model(s) 1126 may output a schedule or recommended future time intervals for future address rotation events where the threshold count is likely to be satisfied.

Although a specific embodiment for a device suitable for configuration with the networking logic for carrying out the various steps, processes, methods, and operations described herein is discussed with respect to FIG. 11, any of a variety of systems and/or processes may be utilized in accordance with embodiments of the disclosure. For example, the device 1100 may be in a virtual environment such as a cloud-based network administration suite, or it may be distributed across a variety of network devices or APs. The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A method comprising:
transmitting, by an access point, one or more wireless frames advertising support for enhanced data privacy (EDP), wherein the one or more wireless frames indicate support for group-based EDP;
determining, by the access point, for one or more epoch groups a number of wireless stations participating in each epoch group of the one or more epoch groups;
transmitting, by the access point, one or more epoch parameters associated with a plurality of epoch groups, wherein a first epoch parameter of the one or more epoch parameters comprises epoch timing information and a second epoch parameter indicates a number of wireless stations participating in the corresponding epoch group;
receiving, by the access point, a wireless action frame transmitted by the wireless station, wherein the wireless action frame indicates a first epoch group of the plurality of epoch groups that the wireless station proposes to join; and
maintaining a wireless connection with the wireless station using a plurality of over-the-air (OTA) medium access control (MAC) addresses for the wireless station that are rotated at an epoch interval associated with the first epoch group.

2. The method of claim 1 wherein the one or more wireless frames advertising support for enhanced data privacy (EDP) are beacon frames.

3. The method of claim 1 wherein the one or more wireless frames advertising support for enhanced data privacy (EDP) are wireless management frames.

4. The method of claim 1 wherein the second epoch parameter identifies a number of wireless stations participating in the corresponding epoch group.

5. The method of claim 1 wherein the one or more epoch parameters are encrypted.

6. A wireless access point comprising:
at least one memory element for storing data; and
at least one processor for executing instructions associated with the data, wherein executing the instructions causes the wireless station to perform operations, comprising:
transmitting one or more wireless frames advertising support for enhanced data privacy (EDP), wherein the one or more wireless frames indicate support for group-based EDP;
determining, by the access point, for one or more epoch groups a number of wireless stations participating in each epoch group of the one or more epoch groups;
transmitting one or more epoch parameters associated with a plurality of epoch groups, wherein a first epoch parameter of the one or more epoch parameters comprises epoch timing information and a second epoch parameter indicates a number of wireless stations participating in the corresponding epoch group;
receiving a wireless action frame transmitted by the wireless station, wherein the wireless action frame indicates a first epoch group of the plurality of epoch groups that the wireless station proposes to join; and
maintaining a wireless connection with the wireless station using a plurality of over-the-air (OTA) medium access control (MAC) addresses for the wireless station that are rotated at an epoch interval associated with the first epoch group.

7. The wireless access point of claim 6 wherein the one or more wireless frames advertising support for enhanced data privacy (EDP) are beacon frames.

8. The wireless access point of claim 6 wherein the one or more wireless frames advertising support for enhanced data privacy (EDP) are wireless management frames.

9. The wireless access point of claim 6 wherein the second epoch parameter identifies a number of wireless stations participating in the corresponding epoch group.

10. The wireless access point of claim 6 wherein the one or more epoch parameters are encrypted.

11. One or more computer readable storage media encoded with software comprising computer executable instructions and when the software is executed by processor in a wireless access point apparatus, cause the processor to perform operations including:
transmitting one or more wireless frames advertising support for enhanced data privacy (EDP), wherein the one or more wireless frames indicate support for group-based EDP;
determining, by the access point, for one or more epoch groups a number of wireless stations participating in each epoch group of the one or more epoch groups;
transmitting one or more epoch parameters associated with a plurality of epoch groups, wherein a first epoch parameter of the one or more epoch parameters comprises epoch timing information and a second epoch parameter indicates a number of wireless stations participating in the corresponding epoch group;
receiving a wireless action frame transmitted by the wireless station, wherein the wireless action frame indicates a first epoch group of the plurality of epoch groups that the wireless station proposes to join; and
maintaining a wireless connection with the wireless station using a plurality of over-the-air (OTA) medium access control (MAC) addresses for the wireless station that are rotated at an epoch interval associated with the first epoch group.

12. The one or more computer readable storage media of claim 11 wherein the one or more wireless frames advertising support for enhanced data privacy (EDP) are beacon frames.

13. The one or more computer readable storage media of claim 11 wherein the one or more wireless frames advertising support for enhanced data privacy (EDP) are wireless management frames.

14. The one or more computer readable storage media of claim 11 wherein the second epoch parameter identifies a number of wireless stations participating in the corresponding epoch group.

15. The one or more computer readable storage media of claim 11 wherein the one or more epoch parameters are encrypted.
